(19) United States
(12) Patent Application Publication
(10) Pub. No.: US 2015/0182951 A1
(43) Pub. Date: Jul. 2, 2015

(54) Phase Stability of Copper-Manganese Spinel Oxide within a Mixture of Metal Oxides

(71) Applicants: Zahra Nazarpoor, Camarillo, CA (US); Stephen J. Golden, Santa Barbara, CA (US)

(72) Inventors: Zahra Nazarpoor, Camarillo, CA (US); Stephen J. Golden, Santa Barbara, CA (US)

(73) Assignee: CLEAN DIESEL TECHNOLOGIES, INC., Oxnard, CA (US)

(21) Appl. No.: 14/657,822

(22) Filed: Mar. 13, 2015

Related U.S. Application Data
(63) Continuation-in-part of application No. 14/098,070, filed on Dec. 5, 2013.

(51) Int. Cl. B01J 23/889; B01J 23/02; B01J 29/76; G01N 23/207; B01J 37/08; B01J 23/10; B01J 35/00; B01J 23/20; B01J 21/06

(52) U.S. Cl. CPC B01J 23/8892; B01J 23/20; B01J 23/02; B01J 29/76; B01J 21/066; B01J 37/08; B01J 23/10; B01J 35/0006; G01N 23/2076

(57) ABSTRACT

The present disclosure describes ZPGM material compositions including a CuMn₂O₄ spinel structure mixed with a plurality of support oxide powders to develop suitable ZPGM catalyst materials. Bulk powder ZPGM catalyst compositions are produced by physically mixing bulk powder CuMn₂O₄ spinel with different support oxide powders calcined at about 1000° C. XRD analyses are performed for bulk powder ZPGM catalyst compositions to determine Cu—Mn spinel phase formation and phase stability for a plurality of temperatures to about 1000° C. ZPGM catalyst material compositions including CuMn₂O₄ spinel mixed with La₂O₃, cordierite, and ceria-zirconia support oxides exhibit phase stability, which can be employed in ZPGM catalysts for a plurality of TWC applications, thereby leading to a more effective utilization of ZPGM catalyst materials with high thermal and chemical stability in TWC products.

### CROSS-REFERENCE TO RELATED APPLICATIONS

This application is a continuation-in-part of U.S. patent application Ser. No. 14/098,070, filed Dec. 5, 2013, the entirety of which is hereby incorporated by reference.

### BACKGROUND

1. Field of the Disclosure

This disclosure relates generally to catalyst materials, and more particularly, to Cu—Mn spinel oxide phase stability within a plurality of support oxides.

2. Background Information

Catalysts in catalytic converters have been used to decrease the pollution associated with exhaust from various sources, such as, automobiles, boats, and other engine-equipped machines. Significant pollutants contained within the exhaust gas of gasoline engines include carbon monoxide (CO), unburned hydrocarbons (HC), and nitrogen oxides (NO_{X}), among others.

Conventional gasoline exhaust systems employ three way catalysts (TWC) technology and are referred to as three way catalyst (TWC) systems. TWC systems work by converting the CO, HC and NO_{X} into less harmful pollutants. Typically, TWC systems include a substrate structure upon which promoting oxides are deposited. Bimetallic catalysts, based on platinum group metals (PGM), are then deposited upon the promoting oxides. PGM materials include Pt, Rh, Pd, Ir, or combinations thereof.

Although PGM catalyst materials are effective for toxic emission control and have been commercialized by the emissions control industry, PGM materials are scarce and expensive. This high cost remains a critical factor for wide spread applications of these catalyst materials. Therefore, there is a need to provide a lower cost TWC system exhibiting catalytic properties substantially similar to or better than the catalytic properties exhibited by TWC systems employing PGM catalyst materials.

### SUMMARY

The present disclosure describes Zero-Platinum Group Metals (ZPGM) material compositions including a CuMn₂O₄ spinel structure mixed with a plurality of support oxide powders to develop suitable ZPGM catalyst materials. Further, the present disclosure describes a process for identifying suitable support oxides capable of providing high thermal stability as well as chemical stability when mixed with CuMn₂O₄ spinel structure to form the aforementioned ZPGM catalyst materials.

According to some embodiments, ZPGM catalyst compositions are produced by physically mixing bulk powder CuMn₂O₄ spinel with selected support oxide powders with a weight ratio of about 1:1, followed by high temperature calcination at about 1000° C. In these embodiments, the support oxide powders selected are Nb₂O₅, SrO, BaO, La₂O₃, cordierite, ceria-zirconia, or mixtures thereof.

In some embodiments, bulk powder ZPGM catalyst compositions are analyzed to determine CuMn₂O₄ spinel phase stability. CuMn₂O₄ spinel phase formation and stability are analyzed/measured using X-ray diffraction (XRD) analyses. In these embodiments, XRD data is analyzed to determine if the structure of the CuMn₂O₄ spinel remains stable. If the structure of the CuMn₂O₄ spinel becomes unstable, new phases will form within the ZPGM catalyst materials.

Cu—Mn spinel phase stability resulting from the use of selected support oxides confirm that ZPGM catalyst compositions including stable Cu—Mn spinel mixed with selected support oxides can be employed for catalyst applications, and more particularly, for ZPGM catalyst applications. Disclosed ZPGM catalyst compositions can provide an essential advantage given the economic factors involved when completely or substantially PGM-free materials are used to manufacture ZPGM catalysts for a plurality of TWC applications.

Numerous other aspects, features, and benefits of the present disclosure may be made apparent from the following detailed description taken together with the drawing figures, which may illustrate the embodiments of the present disclosure, incorporated herein for reference.

### BRIEF DESCRIPTION OF THE DRAWINGS

The present disclosure can be better understood by referring to the following figures. The components in the figures are not necessarily to scale, emphasis instead being placed upon illustrating the principles of the disclosure. In the figures, reference numerals designate corresponding parts throughout the different views.

FIG. 1 is a graphical representation illustrating an X-ray diffraction (XRD) phase stability analysis of CuMn₂O₄ spinel and calcined at about 800° C., according to an embodiment.

FIG. 2 is a graphical representation illustrating an XRD phase stability analysis of Cu—Mn spinel and bulk powder Cu—Mn mixed with Niobium pentoxide support oxide, and both calcined at about 1000° C., according to an embodiment.

FIG. 3 is a graphical representation illustrating an XRD phase stability analysis of Cu—Mn spinel and bulk powder Cu—Mn mixed with Strontium oxide support oxide, and both calcined at about 1000° C., according to an embodiment.

FIG. 4 is a graphical representation illustrating an XRD phase stability analysis of Cu—Mn spinel and bulk powder Cu—Mn mixed with Barium oxide support oxide, and both calcined at about 1000° C., according to an embodiment.

FIG. 5 is a graphical representation illustrating an XRD phase stability analysis of Cu—Mn spinel and bulk powder Cu—Mn mixed with Lanthanum oxide support oxide, and both calcined at about 1000° C., according to an embodiment.

FIG. 6 is a graphical representation illustrating an XRD phase stability analysis of Cu—Mn spinel and bulk powder Cu—Mn mixed with Cordierite support oxide, and both calcined at about 1000° C., according to an embodiment.

FIG. 7 is a graphical representation illustrating an XRD phase stability analysis of Cu—Mn spinel and bulk powder Cu—Mn mixed with Ceria-Zirconia oxide support oxide, and both calcined at about 1000° C., according to an embodiment.

### DETAILED DESCRIPTION

The present disclosure is here described in detail with reference to embodiments illustrated in the drawings, which form a part here. Other embodiments may be used and/or other changes may be made without departing from the spirit or scope of the present disclosure. The illustrative embodiments described in the detailed description are not meant to be limiting of the subject matter presented here.

### Definitions

As used here, the following terms have the following definitions:

“Platinum Group Metals (PGM)” refers to platinum, palladium, ruthenium, iridium, osmium, and rhodium.

“Zero-PGM (ZPGM) Catalyst” refers to a catalyst completely or substantially free of PGM.

“Catalyst” refers to one or more materials that may be of use in the conversion of one or more other materials.

“Calcination” refers to a thermal treatment process applied to solid materials, in presence of air, to bring about a thermal decomposition, phase transition, or removal of a volatile fraction at temperatures below the melting point of the solid materials.

“Treating, Treated, or Treatment” refers to drying, firing, heating, evaporating, calcining, or mixtures thereof.

“Spinel” refers to any minerals of the general formulation AB₂O₄ where the A ion and B ion are each selected from mineral oxides, such as, magnesium, iron, zinc, manganese, aluminum, chromium, or copper, among others.

“Three-Way Catalyst (TWC)” refers to a catalyst able to perform the three simultaneous tasks of reduction of nitrogen oxides to nitrogen and oxygen, oxidation of carbon monoxide to carbon dioxide, and oxidation of unburnt hydrocarbons to carbon dioxide and water.

“X-ray Diffraction (XRD) Analysis” refers to a rapid analytical technique for identifying crystalline material structures, including atomic arrangement, crystalline size, and imperfections in order to identify unknown crystalline materials (e.g., minerals, inorganic compounds).

### Description of the Drawings

The present disclosure describes Zero-Platinum Group Metals (ZPGM) material compositions including a CuMn₂O₄ spinel structure mixed with a plurality of support oxide powders to develop suitable ZPGM catalyst materials. Further, the present disclosure describes a process for identifying suitable support oxides capable of providing high thermal stability as well as chemical stability when mixed with CuMn₂O₄ spinel structure to form the aforementioned ZPGM catalyst materials.

### ZPGM Catalyst Material Composition and Preparation

The disclosed ZPGM material compositions in form of bulk powder are produced from spinel of CuMn₂O₄. In some embodiments, bulk powder of CuMn₂O₄ spinel is produced as described in U.S. patent application Ser. No. 14/098,070.

In some embodiments, bulk powder CuMn₂O₄ spinel is physically mixed with selected support oxide powders with a weight ratio of about 1:1. Then, the mixture of bulk powder Cu—Mn spinel and selected support oxide powders is dried at about 120° C., and calcined at a plurality of temperatures within a range from about 600° C. to about 1000° C. In these embodiments, calcination is preferably performed at about 1000° C. for about 5 hours. Further to these embodiments, support oxide powders selected to determine the Cu—Mn spinel phase stability are Nb₂O₅, SrO, BaO, La₂O₃, cordierite, ceria-zirconia, or mixtures thereof.

### X-ray diffraction analysis for CuMn₂O₄ spinel phase formation and stability

According to some embodiments, Cu—Mn spinel phase formation and stability are subsequently analyzed/measured using X-ray diffraction (XRD) analyses. In these embodiments, XRD data is then analyzed to determine if the structure of the CuMn₂O₄ spinel remains stable. If the structure of the CuMn₂O₄ spinel becomes unstable, new phases will form within the ZPGM catalyst material. Further to these embodiments, different calcination temperatures will result in different CuMn₂O₄ spinel phases.

In some embodiments, XRD patterns are measured on a powder diffractometer using Cu Ka radiation in the 2-theta range of about 15°-100° with a step size of about 0.02° and a dwell time of about 1 second. In these embodiments, the tube voltage and current are set to about 40 kV and about 30 rnA, respectively. The resulting diffraction patterns are analyzed using the International Center for Diffraction Data (ICDD) database to identify phase formation. Examples of powder diffractometer include the MiniFlex™ powder diffractometer available from Rigaku® of The Woodlands, TX.

In other embodiments, XRD analyses identify suitable chemical compositions of the Cu—Mn spinel that when mixed with selected support oxide powders possess phase stability at a plurality of temperatures of operation in TWC applications.

### Copper-Manganese Spinel Oxide Phase Formation and Stability

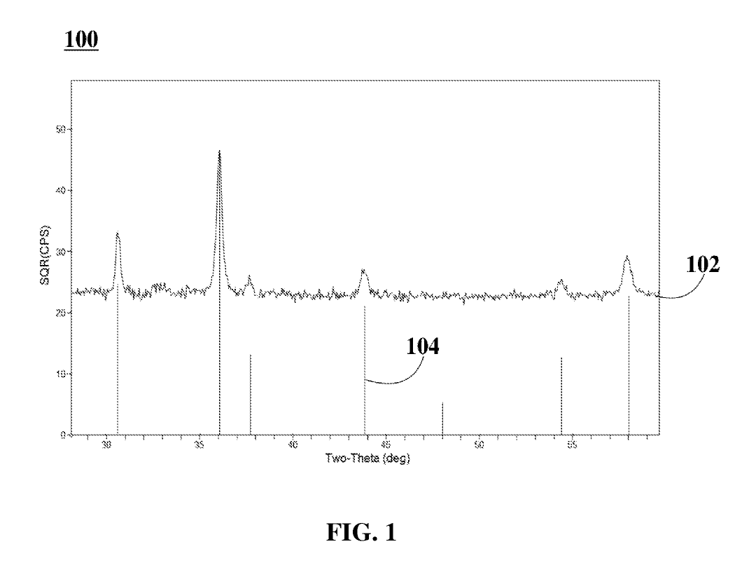

FIG. 1 is a graphical representation illustrating an X-ray diffraction (XRD) phase stability analysis of CuMn₂O₄ spinel and calcined at about 800° C., according to an embodiment.

In FIG. 1, XRD analysis 100 includes XRD spectrum 102 and solid lines 104. XRD spectrum 102 illustrates diffraction peaks of bulk powder Cu—Mn spinel calcined at a temperature of about 800° C. In some embodiments and after calcination, pure CuMn₂O₄ spinel phase is produced, as illustrated by solid lines 104, and the pure CuMn₂O₄ spinel includes no contaminant and no separate oxide phases. This result confirms the presence of pure CuMn₂O₄ spinel oxide phase in the bulk powder spinel produced by co-precipitation method.

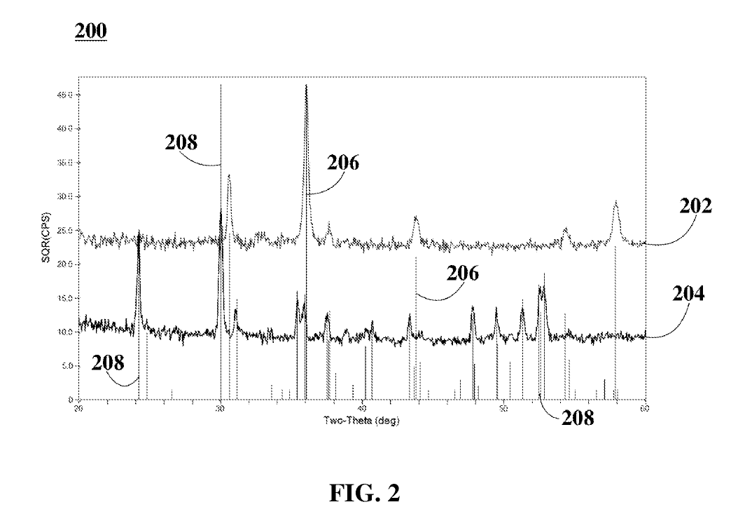

FIG. 2 is a graphical representation illustrating an XRD phase stability analysis of Cu—Mn spinel and bulk powder Cu—Mn mixed with Nb₂O₅ support oxide, and both calcined at about 1000° C., according to an embodiment.

In FIG. 2, XRD analysis 200 includes XRD spectrum 202, XRD spectrum 204, solid lines 206, and solid lines 208. XRD spectrum 202 illustrates bulk powder Cu—Mn spinel, and XRD spectrum 204 illustrates bulk powder Cu—Mn spinel mixed with Nb₂O₅ support oxide and calcined at temperature of about 1000° C. In some embodiments and after calcination, a small intensity of Cu—Mn spinel is produced after mixing the Cu—Mn spinel with Nb₂O₅ support oxide at about 1000° C., as illustrated by solid lines 206. In these embodiments, MnNbO₅ as a new phase is formed, which is the majority phase in the mixture of Cu—Mn spinel and Nb₂O₅, as illustrated by solid lines 208. Further to these embodiments, Nb₂O₅ phase is not anymore produce within the mixture of Cu—Mn spinel and Nb₂O₅ support oxide. In some embodiments, the instability of the Cu—Mn spinel when mixed with the Nb₂O₅ support oxide is evidenced by the presence of a MnNbO₅ phase.

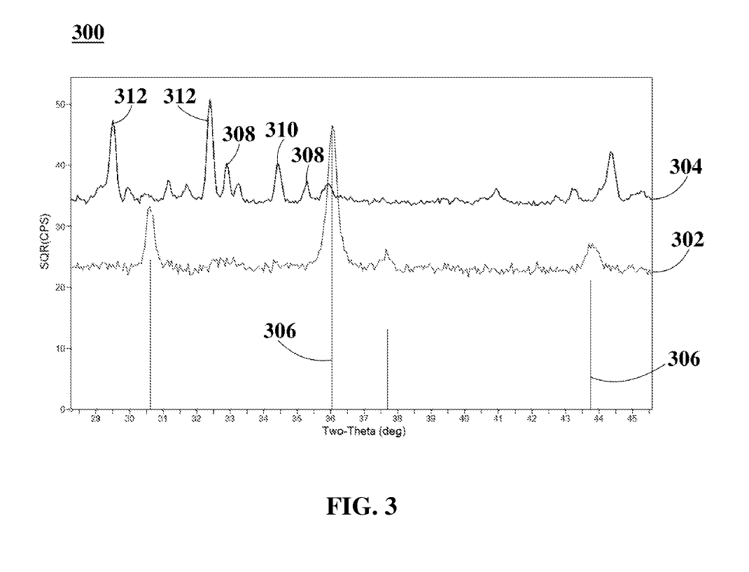

FIG. 3 is a graphical representation illustrating an XRD phase stability analysis of Cu—Mn spinel and bulk powder Cu—Mn mixed with SrO support oxide, and both calcined at about 1000° C., according to an embodiment.

In FIG. 3, XRD analysis 300 includes XRD spectrum 302, XRD spectrum 304, solid lines 306, diffraction peaks 308, diffraction peak 310, and diffraction peaks 312. XRD spectrum 302 illustrates bulk powder Cu—Mn spinel, and XRD spectrum 304 illustrates bulk powder Cu—Mn spinel mixed with SrO support oxide and calcined at temperature of about 1000° C. In some embodiments and after calcination, a small intensity of Cu—Mn spinel is produced after mixing the Cu—Mn spinel with SrO support oxide at about 1000° C., as illustrated by solid lines 306. In these embodiments, SrO phase is not anymore present within the mixture of Cu—Mn spinel and SrO support oxide. Further to these embodiments, SrMnO₃, SrCuO₂, and Sr₄(Mn_{2.1}Cu_{0.9})O₉ as new phases are produced, as illustrated by diffraction peaks 308, diffraction peak 310, and diffraction peaks 312, respectively. In some embodiments, Cu—Mn spinel is not stable when mixed with the SrO support oxide due to the formation of new phases.

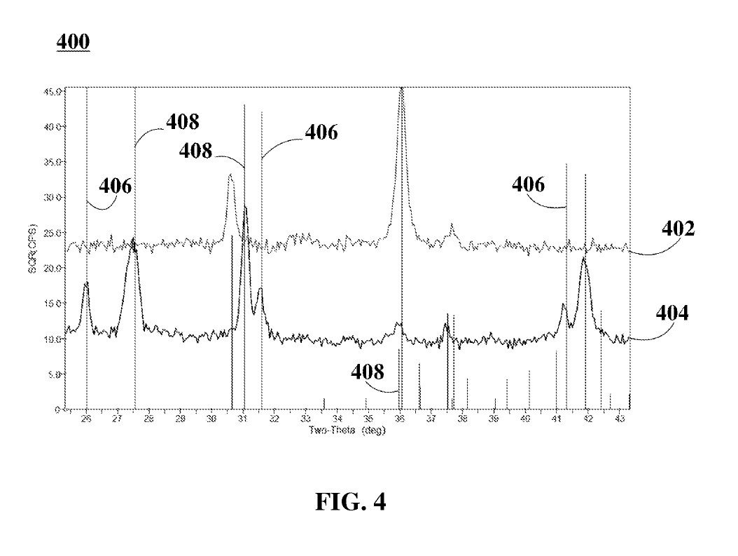

FIG. 4 is a graphical representation illustrating an XRD phase stability analysis of Cu—Mn spinel and bulk powder Cu—Mn mixed with BaO support oxide, and both calcined at about 1000° C., according to an embodiment.

In FIG. 4, XRD analysis 400 includes XRD spectrum 402, XRD spectrum 404, solid lines 406, and solid lines 408. XRD spectrum 402 illustrates bulk powder Cu—Mn spinel, and XRD spectrum 404 illustrates bulk powder Cu—Mn spinel mixed with BaO support oxide, both calcined at a temperature of about 1000° C. In some embodiments and after calcination, Cu—Mn spinel and BaO phases are not anymore produce within the mixture of Cu—Mn spinel and BaO support oxide. Further to these embodiments, BaMnO₃ and Ba₆Mn₄CuO₁₅ as new phases are produced, as illustrated by solid lines 406 and solid lines 408, respectively. In some embodiments, Cu—Mn spinel is not stable when mixed with the BaO support oxide, and completely decomposed into Cu and Mn oxides. Cu and Mn oxides react with the BaO support oxide and subsequently form new phases.

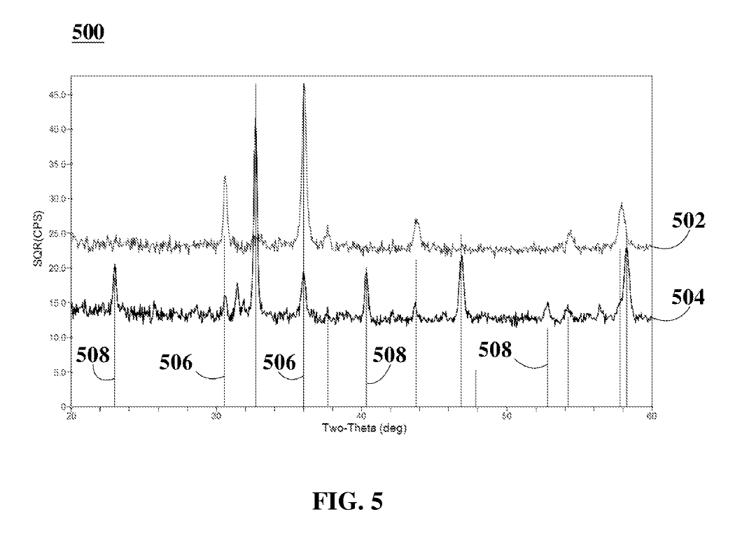

FIG. 5 is a graphical representation illustrating an XRD phase stability analysis of Cu—Mn spinel and bulk powder Cu—Mn mixed with La₂O₃ support oxide, and both calcined at about 1000° C., according to an embodiment.

In FIG. 5, XRD analysis 500 includes XRD spectrum 502, XRD spectrum 504, solid lines 506, and solid lines 508. XRD spectrum 502 illustrates bulk powder Cu—Mn spinel, and XRD spectrum 504 illustrates bulk powder Cu—Mn spinel mixed with La₂O₃ support oxide powder samples, and both calcined at a temperature of about 1000° C. In some embodiments and after calcination, Cu—Mn spinel phase is still produced with good intensity within the mixture of Cu—Mn spinel and La₂O₃ support oxide, as illustrated by solid lines 506. Further to these embodiments, La₂O₃ phase is not anymore produce within the mixture of Cu—Mn spinel and La₂O₃ support oxide. Still further to these embodiments, LaMnO₃ perovskite as a new phase is produced from the Cu—Mn spinel partial decomposition, as illustrated by solid lines 508. In some embodiments, Cu—Mn spinel is partially stable when mixed with La₂O₃ support oxide.

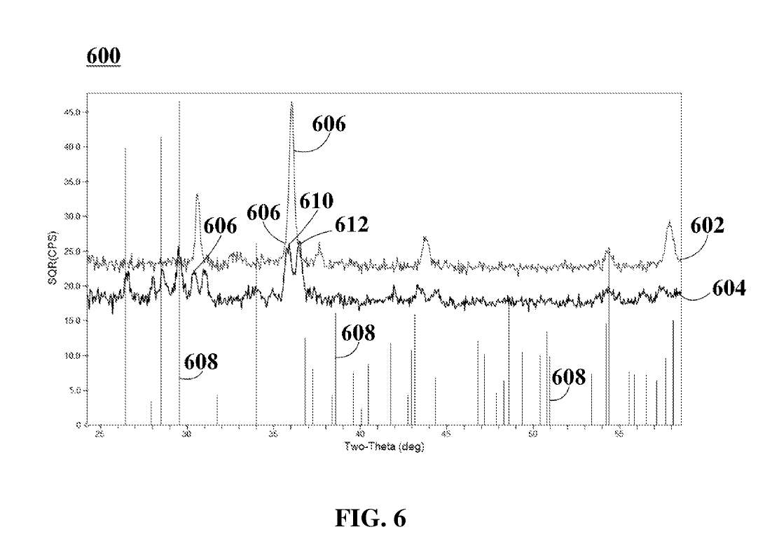

FIG. 6 is a graphical representation illustrating an XRD phase stability analysis of Cu—Mn spinel and bulk powder Cu—Mn mixed with cordierite support oxide, and both calcined at about 1000° C., according to an embodiment.

In FIG. 6, XRD analysis 600 includes XRD spectrum 602, XRD spectrum 604, diffraction peaks 606, solid lines 608, diffraction peak 610, and diffraction peak 612. XRD spectrum 602 illustrates bulk powder Cu—Mn spinel, and XRD spectrum 604 illustrates bulk powder Cu—Mn spinel mixed with cordierite support oxide, and both calcined at a temperature of about 1000° C. In some embodiments and after calcination, a small intensity of Cu—Mn spinel is produced within the mixture of Cu—Mn spinel and cordierite support oxide, as illustrated by diffraction peaks 606. In these embodiments, cordierite phase is significantly produced within the mixture of Cu—Mn spinel and cordierite support oxide, as illustrated by solid lines 608. Further to these embodiments, Cu—Mn spinel is decomposed into Mn and Cu oxides, but does not form new phases with cordierite support oxide. Mn₃O₄ and Cu₂O phases are produced from Cu—Mn spinel decomposition, as illustrated by diffraction peak 610 and diffraction peak 612, respectively. Still further to these embodiments, cordierite plays as an inert support oxide for bulk CuMn₂O₄ spinel since there is no chemical interaction between them. In some embodiments, Cu—Mn spinel or spinel decomposition products exhibit no interaction with cordierite support oxide.

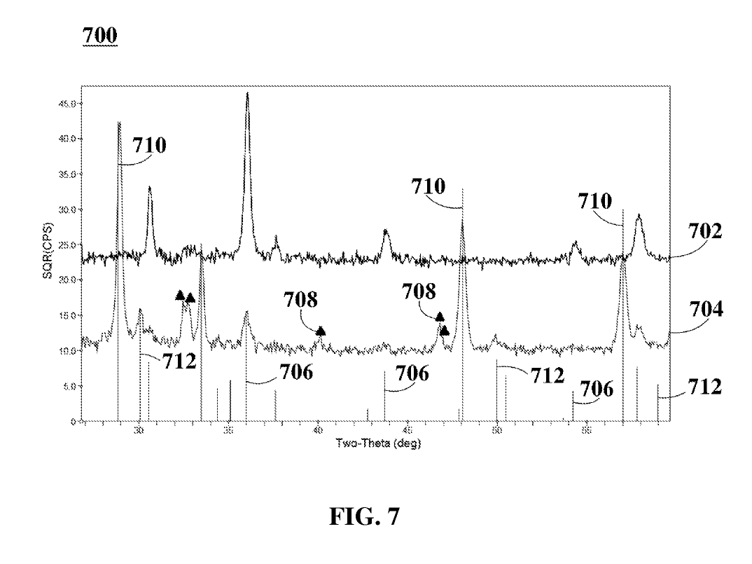

FIG. 7 is a graphical representation illustrating an XRD phase stability analysis of Cu—Mn spinel and bulk powder Cu—Mn mixed with ceria-zirconia oxide support oxide, and both calcined at about 1000° C., according to an embodiment.

In FIG. 7, XRD analysis 700 includes XRD spectrum 702, XRD spectrum 704, solid lines 706, solid triangles 708, solid lines 710, and solid lines 712. XRD spectrum 702 illustrates bulk powder Cu—Mn spinel, and XRD spectrum 704 illustrates bulk powder Cu—Mn spinel mixed with ceria-zirconia support oxide, and both calcined at a temperature of about 1000° C. In some embodiments and after calcination, a small intensity of Cu—Mn spinel is produced, as illustrated by solid lines 706. In these embodiments, Mn₃O₄ as a decomposition product of Cu—Mn spinel is produced, as illustrated by solid triangles 708. Further to these embodiments, Ce_{0.75}Zr_{0.5}O₂ phase that corresponds to fluorite phase of ceria-zirconia support oxide is produced, as illustrated by solid lines 710, as well as tetragonal ZrO₂, as illustrated by solid lines 712. Still further to these embodiments, there is no chemical interaction between the ceria-zirconia support oxide and spinel or spinel decomposition products. Therefore, ceria-zirconia support oxide is stable and remains intact after mixing with the Cu—Mn spinel. In some embodiments, ceria-zirconia support oxide and CuMn₂O₄ spinel exhibit no chemical interaction.

According to the principles of this present disclosure, use of different support oxide powders brings different CuMn₂O₄ spinel phase stabilities. The stabilities are determined from the XRD analysis results of the disclosed bulk powder ZPGM catalyst compositions of spinel and different support oxides. In the present disclosure, Nb₂O₅, BaO and SrO support oxide powders exhibit significant chemical interaction with Cu—Mn spinel. Additionally, interaction of Cu—Mn spinel with BaO, SrO and Nb₂O₅ support oxide powders form new phases, thereby indicating that Cu—Mn spinel phase is not stable and mixed oxide phase from support oxide interacts with spinel decomposition products (i.e., Cu and Mn oxides, new phases). Interaction of Cu—Mn spinel with La₂O₃ support oxide powder forms, to some extent, LaMnO₃ perovskite from spinel partial decomposition. It is noted that Cu—Mn spinel is partially stable when mixed with La₂O₃ support oxide. Cordierite and ceria-zirconia support oxide powders exhibit no chemical interaction with Cu—Mn spinel. As such, cordierite and ceria-zirconia support oxide powders remain stable when mixed with the Cu—Mn spinel.

ZPGM catalyst compositions including stable a Cu—Mn spinel structure mixed with La₂O₃, cordierite, and ceria-zirconia support oxide powders can be employed in ZPGM catalysts for a plurality of TWC applications. Using the aforementioned ZPGM catalyst material compositions results in higher thermal and chemical stability within TWC products.

While various aspects and embodiments have been disclosed, other aspects and embodiments may be contemplated. The various aspects and embodiments disclosed here are for purposes of illustration and are not intended to be limiting, with the true scope and spirit being indicated by the following claims.

What is claimed is:

1. A composition comprising a catalyst comprising CuMn₂O₄ spinel and an oxide powder selected from the group consisting of Nb₂O₅, SrO, BaO, La₂O₃, CeO₂—ZrO₂, cordierite, and mixtures thereof.

2. The composition of clam 1, wherein the catalyst is calcined at about 1000° C.

3. A composition comprising a catalyst comprising CuMn₂O₄ spinel and an oxide powder comprising Ce_{0.75}Zr_{0.5}O₂.

4. The composition of clam 3, wherein the catalyst is calcined at about 1000° C.

5. A method for determining the phase stability of bulk CuMn₂O₄ spinel in selected support oxides, comprising:
providing a mixture comprising CuMn₂O₄ spinel and a plurality of metals; and
analyzing the mixture using x-ray diffraction to produce a graph having at least one defined peak;
wherein at least one defined peak is representative of a stable CuMn₂O₄ spinel and metal combination.

6. The method of claim 3, wherein at least one of the at least one defined peak represents a composition comprising CuMn₂O₄ spinel and an oxide powder selected from the group consisting of Nb₂O₅, SrO, BaO, La₂O₃, CeO₂—ZrO₂, cordierite, and mixtures thereof.

7. The method of claim 3, wherein the calcination is at about 1000° C.

8. A catalytic system, comprising:
a substrate;
a washcoat suitable for deposition on the substrate; and
an overcoat suitable for deposition on the substrate, the overcoat comprising a catalyst comprising CuMn₂O₄ spinel and an oxide powder.

9. The system of claim 8, wherein the oxide powder selected from the group consisting of Nb₂O₅, SrO, BaO, La₂O₃, CeO₂—ZrO₂, cordierite, and mixtures thereof.

10. The system of claim 8, wherein the catalyst is calcined at about 1000° C.

11. The system of claim 8, wherein the oxide powder comprising Ce_{0.75}Zr_{0.5}O₂.

12. The system of claim 8, wherein CO is oxidized by the catalyst.

13. The system of claim 8, wherein hydrocarbons are oxidized by the catalyst.

14. The system of claim 8, wherein NOₓ is reduced by the catalyst.
